(19) United States
(12) Patent Application Publication
(10) Pub. No.: US 2006/0187136 A1
(43) Pub. Date: Aug. 24, 2006

(54) Electronic apparatus with television box equipped plate antenna

(76) Inventors: Shih-Pin Lo, Taipei (TW); Li-Hsiang Liao, Taipei (TW); Chin-Yi Wu, Taipei (TW); Chun-Kai Chan, Taipei (TW)

Correspondence Address: RABIN & Berdo, PC, 1101 14TH STREET, NW, SUITE 500, WASHINGTON, DC, 20005, US

(21) Appl. No.: 11/359,577

(22) Filed: Feb. 23, 2006

(30) Foreign Application Priority Data
Feb. 24, 2005 (TW) 94105677

(51) Int. Cl. H01Q 9/28

(52) U.S. Cl. 343/795

(57) ABSTRACT

An electronic apparatus with television box includes a host and a plate antenna. The host has a surface. The plate antenna is electrically connected to and pivotally connected to the host. The plate antenna covers the surface of the host when the plate and the host are closed.

This application claims the benefit of Taiwan application Serial No. 94105677, filed Feb. 24, 2005, the subject matter of which is incorporated herein by reference.

### BACKGROUND OF THE INVENTION

1. Field of the Invention

The invention relates in general to an electronic apparatus with television box, and more particularly to a television box equipped with a plate antenna.

2. Description of the Related Art

FIG. 1 is a schematic illustration showing a structure of a conventional television box. As shown in FIG. 1, a conventional television box 100 itself cannot receive a wireless signal directly, but can receive the wireless signal through an antenna device 110 after a plug 111 of the antenna device 110 is electrically connected to a hole 102 of the television box 100.

The television box 100 can receive analog signal or a digital signal. The digital signal may be the wireless signal having a digital television specification such as the DVB-T (Digital Video Broadcasting Television) specification, the ATSC (Advanced Television Systems Committee) specification, or the ISDB (Integrated Services Digital Broadcasting) specification. The DVB-T specification is the European specification adopted in European countries and Taiwan. The ATSC specification is the U.S. specification, while the ISDB specification is the Japanese specification.

However, the conventional television box 100 has to be connected to the antenna device 110 externally. Thus, the conventional television box 100 cannot be easily carried, or tends to catch other things and thus to be damaged.

### SUMMARY OF THE INVENTION

It is therefore an object of the invention to provide a television box equipped with a plate antenna.

The invention achieves the above-identified object by providing a television box including a host and a plate antenna. The host has a surface. The plate antenna is electrically connected to and pivotally connected to the host. The plate antenna covers the surface of the host when they are closed.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 is a schematic illustration showing a structure of a conventional television box.

FIGS. 2A and 2B are schematic illustrations showing a structure of a television box with a plate antenna according to a preferred embodiment of the invention.

FIG. 3A is a schematic illustration showing a structure of a mazy plate antenna.

FIG. 3B is a schematic illustration showing a structure of a Z-shaped plate antenna.

FIG. 3C is a schematic illustration showing a structure of a folded plate antenna.

FIG. 3D is a schematic illustration showing a structure of another folded plate antenna.

FIG. 3E is a schematic illustration showing a structure of a vortical plate antenna.

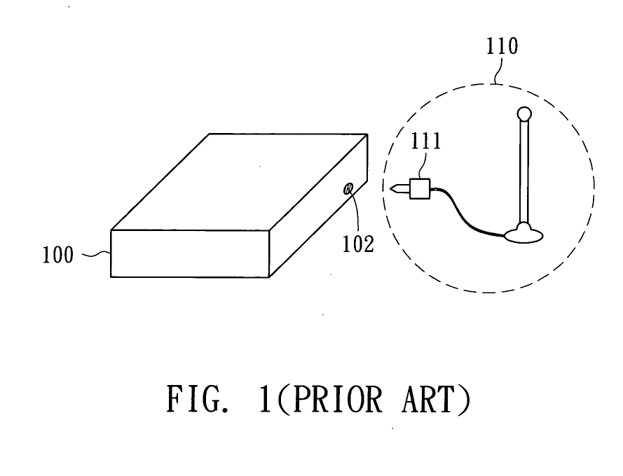

### DETAILED DESCRIPTION OF THE INVENTION

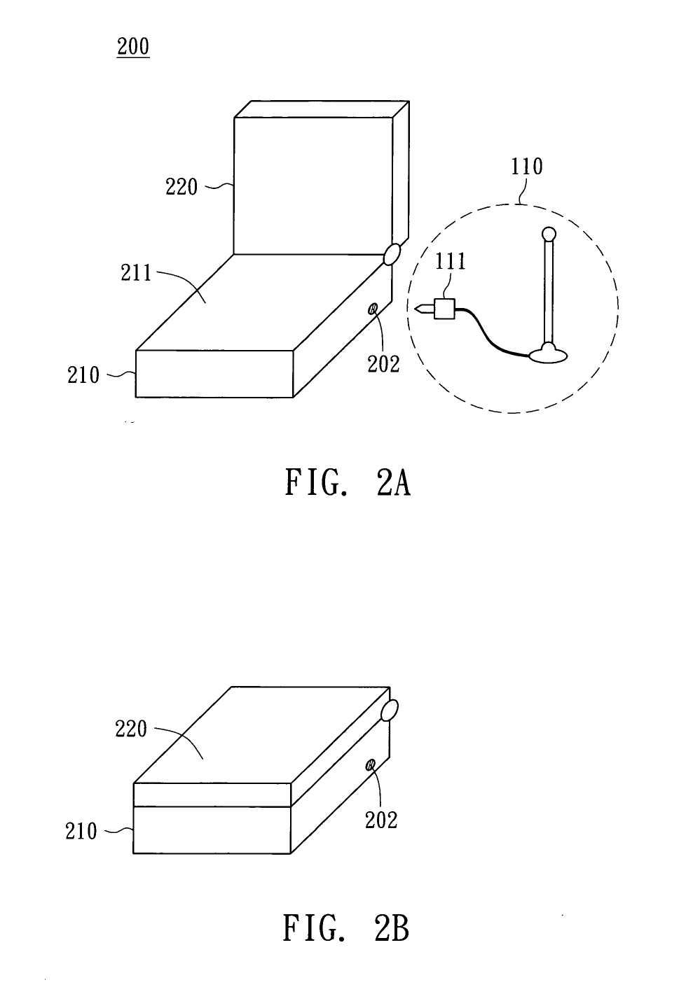

FIGS. 2A and 2B are schematic illustrations showing a structure of a television box with a plate antenna according to a preferred embodiment of the invention. Referring to FIGS. 2A and 2B, the television box 200 includes a host 210 and a plate antenna 220. The television box 200 may be, for example a USB (Universal Serial Bus) television box. The plate antenna 220 is electrically connected to and pivotally connected to the host 210. The plate antenna 220 covers a surface 211 of the host 210 when they are closed.

For example, the host 210 may be coupled to the plate antenna 220 through a hinge such that the plate antenna 220 can be pivotally connected to the host 210. When the television box 200 is utilized to receive the television program, open the plate antenna 220 to enhance the ability of signal receiving. If the user does not want to receive the television program, close the plate antenna 220 for storing or carrying conveniently.

In addition, the host 210 further includes an extended antenna hole 202. When the signal receiving, is poor the plate antenna 220 is externally connected to an antenna device 110 through the extended antenna hole 202 so that the signal receiving can be enhanced. The antenna device 110 may be a dipole antenna, a monopole antenna or a loop antenna according to the requirements.

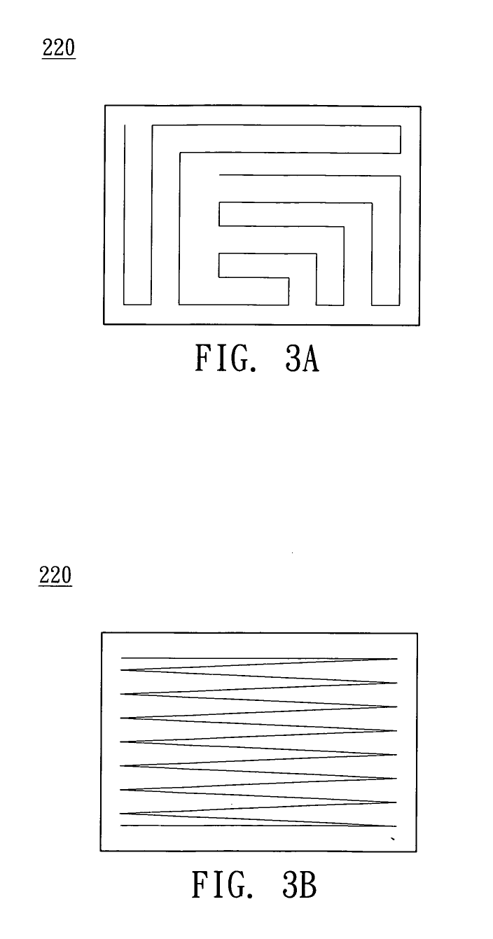

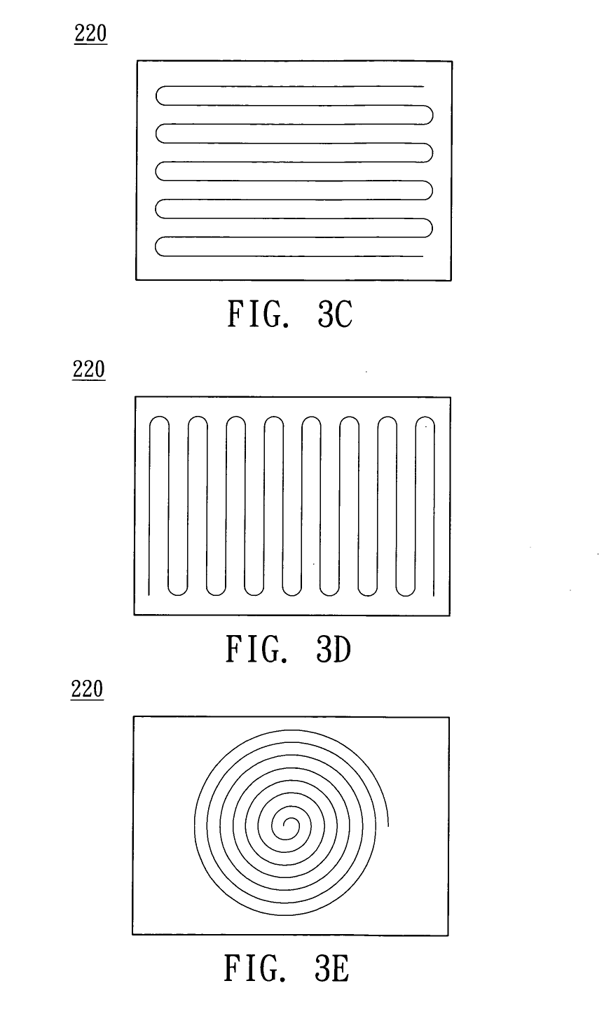

FIGS. 3A to 3E show various structures of the plate antenna 220. FIG. 3A is a schematic illustration showing a structure of a mazy plate antenna. The mazy plate antenna layouts a metal wire in a mazy manner in order to increase the wire length to match the signal and enhance the signal receiving ability. FIG. 3B is a schematic illustration showing a structure of a Z-shaped plate antenna. The Z-shape plate antenna layouts a metal wire into a Z-shape in order to increase the wire length to match the signal. FIG. 3C is a schematic illustration showing a structure of a folded plate antenna. The folded plate antenna layouts a metal wire into a round trip vertically in order to increase the wire length to match the signal. FIG. 3D is a schematic illustration showing a structure of another folded plate antenna. The folded plate antenna also layouts a metal wire into a round trip horizontally. FIG. 3E is a schematic illustration showing a structure of a spiral plate antenna. The spiral plate antenna layouts a metal wire into a spiral shape.

The television box 200 can receive an analog signal or a digital signal. The digital television box 200 can receive a wireless signal having a digital television specification, such as the DVB-T (Digital Video Broadcasting Television) specification, the ATSC (Advanced Television Systems Committee) specification or the ISDB (Integrated Services Digital Broadcasting) specification, through the above-mentioned plate antennas. The DVB-T specification is the European specification adopted in European countries and Taiwan. The ATSC specification is the U.S. specification, while the ISDB specification is the Japanese specification.

The television box according to the embodiment of the invention has the plate antenna and is pivotally connected to the host of the television box. As the result, the television box can be easily carried and resolve the damage problem of the conventional television box that hooking or attaching foreign objects.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic apparatus with television function, comprising:
a host having a surface; and
a plate antenna electrically connected to and pivotally connected to the host, wherein the plate antenna covers the surface when the plate antenna and the host are closed.

2. The electronic apparatus with television function according to claim 1,
wherein the plate antenna layouts a wire in a mazy manner.

3. The electronic apparatus with television function according to claim 1,
wherein the plate antenna layouts a wire into a Z-shape.

4. The electronic apparatus with television function according to claim 1,
wherein the plate antenna layouts a wire into a spiral shape.

5. The electronic apparatus with television function according to claim 1,
wherein the plate antenna layouts a wire in a round trip.

6. The electronic apparatus with television function according to claim 1,
wherein the host comprises an extended antenna hole to be externally connected to an antenna device.

7. The electronic apparatus with television function according to claim 6,
wherein the antenna device is a dipole antenna.

8. The electronic apparatus with television function according to claim 1,
wherein the television box is a USB (Universal.Serial Bus) television box.

9. The electronic apparatus with television function according to claim 1,
wherein the television box receives a wireless signal with a digital television specification.

10. The electronic apparatus with television function according to claim 9,
wherein the digital television specification is a DVBT (Digital Video Broadcasting Television) specification.

11. The electronic apparatus with television function according to claim 9,
wherein the digital television specification is an ATSC (Advanced Television Systems Committee) specification.

12. The electronic apparatus with television function according to claim 9,
wherein the digital television specification is an ISDB (Integrated Services Digital Broadcasting) specification.
